(19) United States
(12) Patent Application Publication
(10) Pub. No.: US 2016/0374258 A1
(43) Pub. Date: Dec. 29, 2016

(54) ARM BRACKET

(71) Applicant: SCHAFFERT MANUFACTURING COMPANY, INC., Indianola, NE (US)

(72) Inventor: Paul E. Schaffert, Indianola, NE (US)

(21) Appl. No.: 15/191,305

(22) Filed: Jun. 23, 2016

Related U.S. Application Data
(60) Provisional application No. 62/183,590, filed on Jun. 23, 2015.

(51) Int. Cl. A01B 63/24

(52) U.S. Cl. CPC A01B 63/24; A01C 7/06

(57) ABSTRACT

A bracket for use with an agriculture planter including a trailing arm frame defining a pivot point thereon may include an arm bracket assembly with first, second, third, and fourth arms. Each arm may extend from a middle portion of the bracket. First and second fertilizer furrow opening discs may be rotatably mounted on mounting ends of two of the arms. First and second furrow closing wheels may be rotatably mounted on a mounting end of the other two arms. The middle portion of the bracket may be pivotally coupled to the trailing arm frame at the pivot point. The arms joined to the fertilizer furrow opening discs may be arranged at opposing ends of the middle portion to enable the furrow opening discs to open two fertilizer furrows on opposing sides of a seed furrow.

### CROSS REFERENCE TO RELATED APPLICATIONS

The present application claims priority pursuant to 35 U.S.C. §119(e) to U.S. provisional application No. 62/183,590, filed Jun. 23, 2015 entitled “Arm Bracket”, which is hereby incorporated herein by reference in its entirety.

### BACKGROUND

Agricultural seed planting is typically accomplished by multi-row planters. Each planter may include multiple row units adapted for opening a seed furrow, depositing seeds within the furrow, and closing the seed furrow around the seeds. In some cases, each row unit of the planter may also open a fertilizer furrow adjacent to each seed furrow, deposit liquid fertilizer in each fertilizer furrow, and close each fertilizer furrow.

Each row unit of the planter may include an articulating chassis that supports furrow opening discs and furrow closing or press wheels. As each row unit travels along the planting area, the row units may encounter debris, for example, root balls, cobbs, stalks, etc. This debris (also referred to as “trash”) may interfere with the operation of the row unit. In some instances, the debris may be caught or lodged between the chassis and the ground, which may result in the row unit dragging the debris throughout the planting area. The caught or lodged debris may further result in debris buildup in front of the row units. The caught or lodged debris, along with any debris buildup, may adversely affect seed placement and/or liquid fertilization distribution. For example, uneven seed placement may result in some seeds being placed too deep or too shallow within the furrow. Also, uneven seed placement may result in some seeds being offset from a row, which may cause the seed to receive inadequate fertilizer and/or water and/or to be trampled by people or equipment if the seed is able to germinate. Similarly, if the liquid fertilizer is offset and is unevenly distributed, some seeds may not receive any fertilizer and may not germinate and others may receive too much fertilizer and may die. Further, the caught or lodged debris, along with any debris buildup, may create trenches in the planting area, which may redirect water flow in the planting area, cause erosion of the planting area (e.g., water erosion), or result in other unintended consequences that may adversely affect the yield of the planting area. Examples of these chassis are disclosed in U.S. Pat. No. 8,356,563; U.S. Patent Pub. No. 2013/0263767; and U.S. Patent Pub. No. 2013/0074747.

Numerous manufactures provide planter units that the chassis may be useful with. However, universal adoption of the same chassis may be difficult. For example, some of the planters need modified in order to work with articulating chassis. For example, the Monosem planter unit is wide so that it interferes with traditional articulating chassis. As such, to make the Monosem planter work, a side wall is cut out. Additionally, traditional chassis may be harder to work on as they require more tools and offer less flexibility in dealing with different crops and soil conditions. As such, an improved chassis design is desirable.

### SUMMARY

The present disclosure relates to a row unit for an agricultural planter. In various embodiments of an agriculture planter, the planter may include a bracket. The bracket may be for use with an agriculture planter. The planter may comprise a trailing arm frame defining a pivot point thereon. The bracket may comprise a first arm, a second arm, and a third arm, with each of the arms having a first end joined to a middle portion of the bracket. Two of the arms may include second ends having mounting tabs with a rotatably fixed disc supports extending therefrom. The rotatably fixed disc supports may be operable to selectively receive at least one of a furrow opener disc or furrow closer wheel. The two arms for receiving the fertilizer furrow opener disc may enable two fertilizer furrows to be opened on opposing sides of a seed furrow.

In various embodiments, the rotatably fixed disc support may have portions that extend from both sides of the mounting tab. The rotatably fixed disc support may extend less than the thickness of the mounting tab from the side of the mounting tab opposite the side which receives the at least one of a furrow opener disc or furrow closer wheel. The rotatably fixed disc support may be received through and aperture in the mounting tab. The aperture in the mounting tab may be square. The rotatably fixed disc support may be a bolt which extends through and keys with the aperture. The rotatably fixed disc support may be a carriage bolt. The rotatably fixed disc support may receive a spacer on the side of the mounting tab that receives the at least one of a furrow opener disc or furrow closer wheel. The spacer may be an interchangeable bushing that offsets the at least one of a furrow opener disc or furrow closer wheel away from the mounting tab. Each of the first arm, the second arm, and the third arm, the middle portion, the mounting tab, and the apertures may form an integral molded part.

In various embodiments of an agriculture planter, the planter may include a trailing arm frame defining a pivot point thereon. The bracket may include a first arm, a second arm, and a third arm, with each of the arms having a first end joined to a middle portion of the bracket. Two of the arms may include second ends having mounts with selectively moveable disc spacers which are operable to selectively receive at least one of a furrow opener disc or furrow closer wheel. The selectively moveable bushings may position the at least one of a furrow opener disc or furrow closer wheel at varying distances from the bracket.

In various embodiments, each of the mounts may include a rotatably fixed disc supports extending therefrom. The rotatably fixed disc support may receive the selectively moveable disc spacer. The rotatably fixed disc support and the selectively moveable disc spacers may be separable from the otherwise integral bracket. A first opener disc may be received onto the rotatably fixed disc support and engage against the selectively moveable disc spacer thereby offsetting the first opener disc from a body of the agriculture planter.

While multiple embodiments of planters with equalizer assemblies are described herein, still other embodiments will become apparent to those skilled in the art from the following detailed description. As will be realized, planters with equalizer assemblies are capable of modifications in various aspects. Accordingly, the drawings and detailed description are to be regarded as illustrative in nature and not restrictive.

### BRIEF DESCRIPTION OF THE DRAWINGS

FIG. 1 is an isometric view of a tractor pulling a seed planter.

FIG. 2 is top rear partial isometric view of the seed planter illustrated in FIG. 1 including a plurality of row units each having an example mounting bracket.

FIG. 3 is a top rear isometric view of one row unit of the plurality of row units illustrated in FIG. 2.

FIG. 4 is a top rear isometric view of one row unit of the plurality of row units with the wheels and discs removed.

FIG. 5 is a side view of a type of row unit with the wheels, discs, and their respective shafts removed.

FIG. 6 is a side view of another type of row unit with the wheels, discs, and their respective shafts removed.

FIG. 7 is an exploded top rear isometric view of the row unit illustrated in FIG. 4.

FIG. 7A is a detailed view of FIG. 7 taken along line 7A-7A around an example of the mounting feature.

FIG. 8 is an isometric view of the chassis of FIG. 4.

FIG. 9 is a side elevation view of the chassis and the mounting bracket illustrated in FIG. 4.

FIG. 10 is a rear elevation view of the chassis and the mounting bracket illustrated in FIG. 4.

### DETAILED DESCRIPTION

Disclosed herein is a mounting bracket for use with agricultural mobile devices, such as planters, rippers, coulters, drills and the like. The mounting bracket may be associated with a tail section of a row unit (e.g., a drill assembly, fertilizer assembly, planting assembly, ripper, coulter, etc.). The mounting bracket may interconnect a body of the tail section to a chassis of the tail section. The mounting bracket may be positioned on an upper or top side of the chassis, thereby not obstructing a bottom profile of the chassis. This positioning of the mounting bracket may provide the chassis with additional ground clearance compared to conventional mounting brackets.

The mounting bracket also may provide a pivotable connection between the body and the chassis of a tail section of a row unit. As a tractor (or other device) pulls or tows a row unit across a planting area, the row unit may encounter debris, uneven ground, or other disturbances. The mounting bracket may enable the chassis to move over the debris, uneven ground, or other disturbance while the wheels remain in contact with the ground.

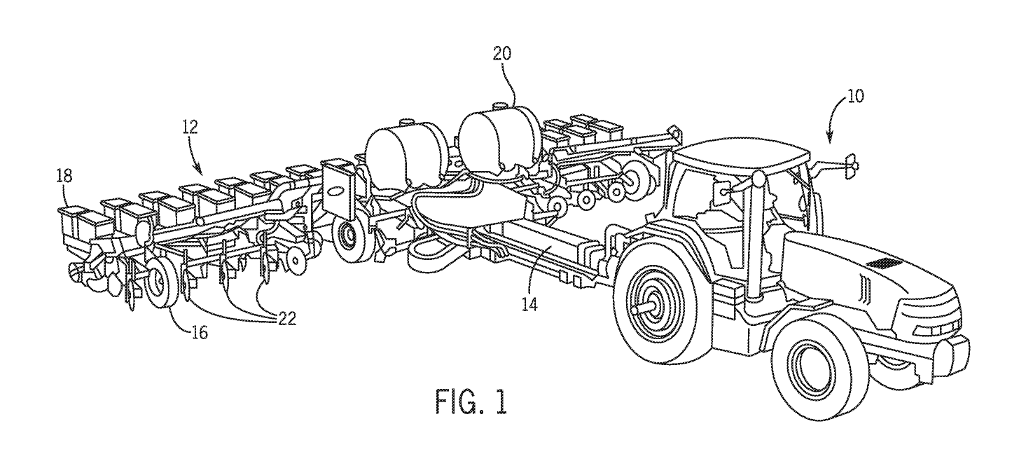

FIG. 1 illustrates a tractor 10 pulling a planter assembly 12. The planter assembly 12 may include a tongue 14 configured to attach to a rear portion of the tractor 10 and wheels 16 configured to support the planter assembly 12. The planter assembly 12 also may include a seed hopper 18, a fertilizer storage tank 20, and seed discs 22. The seed hopper 18 may be configured store a plurality of seeds before the seeds are deposited into a seed furrow. The fertilizer storage tank 20 may be configured to store fertilizer before the fertilizer is deposited within a seed furrow or an adjacent fertilizer furrow. The seed discs 22 may be configured to create or open seed furrows, for example, as the tractor 10 tows the planter assembly 12 along a field. The seed discs 22 may be configured to create a slit, a slot, or a generally V-shaped furrow in the ground.

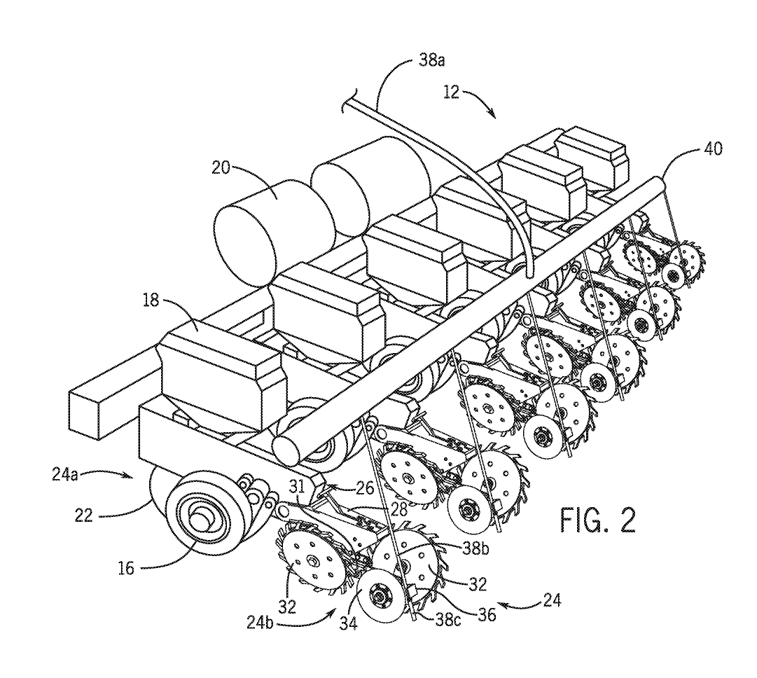

FIG. 2 illustrates a partial enlarged view of the planter assembly 12. The planter assembly 12 may include a plurality of row units 24 each associated with an individual row of a field. Each row unit 24 may include a front section 24a and a rear or tail section 24b. The front section 24a of each row unit 24 may be include a seed disc 22 configured to open a seed furrow and a depositing assembly 26 configured to deposit seeds within the seed furrow. The depositing assembly 26 may receive seeds from a seed hopper 18 associated with the respective row unit 24. Each depositing assembly 26 may include a seed tube and a rebounder, for example, to deposit the seeds in the seed furrow.

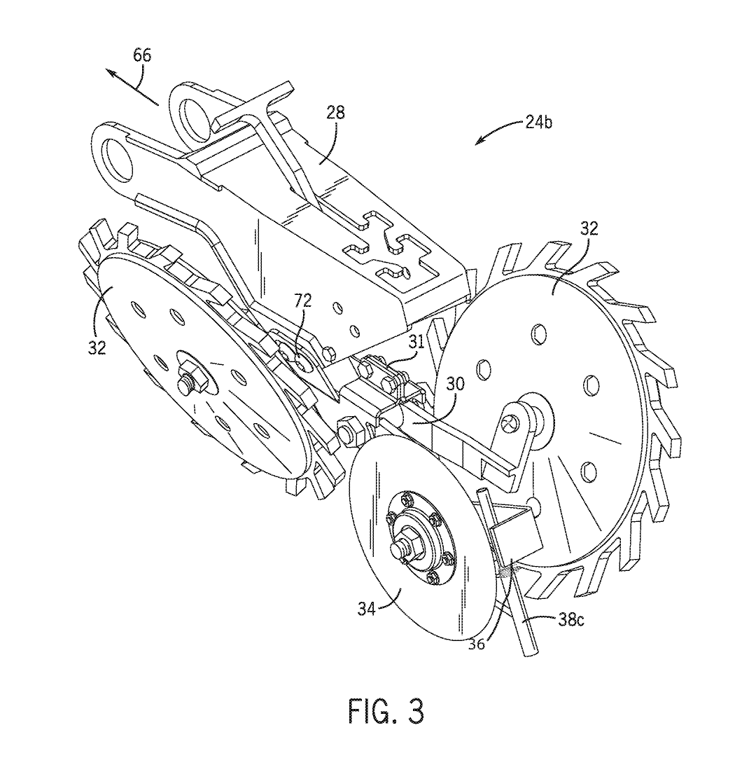

The tail section 24b of each row unit 24 is enlarged in FIG. 3. The tail section 24b may include a body 28 configured to connect the tail section 24b to the front section 24a of a respective row unit 24, a chassis 30 pivotably coupled to the body 28 by a mounting bracket 31, a pair of longitudinally staggered wheels 32 rotatably coupled to the chassis 28, a fertilizer disc 34 rotatably coupled to the chassis 28, and a fertilizer assembly 36 coupled to the chassis 28. Each of the wheels 32 may have a positive camber such that the bottom portions of the pair of wheels 32 are closer to one another than the top portions of the pair of wheels 32. The pair of wheels 32 associated with an individual row unit 24 may be configured to close a seed furrow after the depositing assembly 26 has placed seeds in the seed furrow. Each wheel 32 may be spiked to assist in closing the seed furrow. For example wheel 32 may be a mohawk style closing wheel. But, any type of implement wheel may be used such as disc style closing wheels (flat or concave), mohawk style, press wheels or any other soil conditioning wheel known in the industry.

The fertilizer disc 34 may be configured to create or open a fertilizer furrow. The fertilizer disc 34 may be aligned with or laterally offset from the seed disc 22 such that a resulting fertilizer furrow is aligned with or laterally adjacent a respective seed furrow. The fertilizer assembly 36 may be fluidly connected to a fertilizer storage tank 20 (see FIG. 1) via one or more fertilizer tubes 38 and configured to deliver fertilizer into a fertilizer furrow as the tractor 10 pulls the planter assembly 12 through a field.

With reference back to FIG. 2, an example fertilizer system includes a first fertilizer tube 38a that fluidly connects a fertilizer storage tank 20 (see FIG. 1) to a fertilizer bar or manifold 40. A pump (not illustrated) may deliver the fertilizer from the fertilizer storage tank 20 to the fertilizer bar 40 via the first fertilizer tube 38a. A set of second fertilizer tubes 38b may fluidly connect the fertilizer bar 40 to a set of third fertilizer tubes 38c, each of which may be associated with an individual row unit 24. In an alternative implementation, the second and third sets of fertilizer tubes 38b, 38c may be replaced with a single set of fertilizer tubes, each of which transport the fertilizer from the fertilizer bar 40 directly to an individual fertilizer furrow.

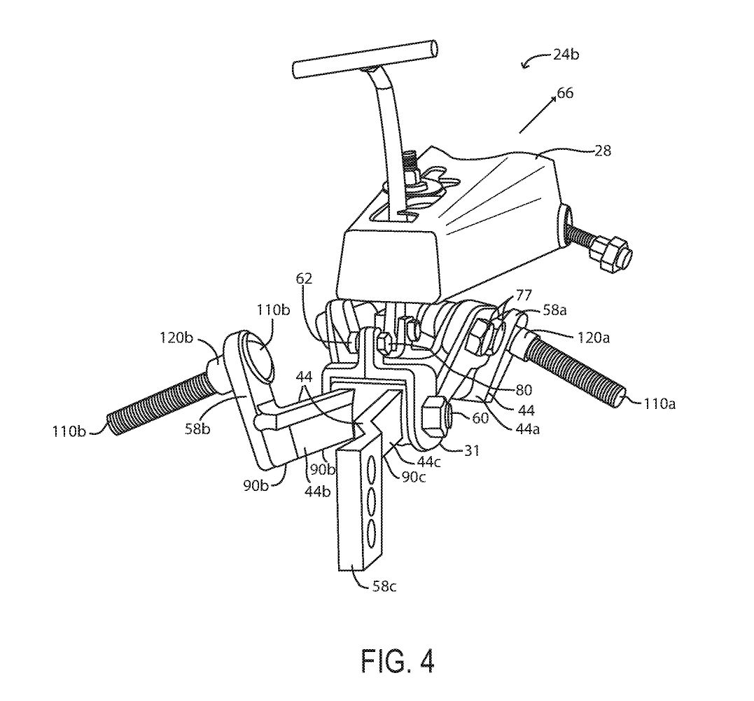

FIG. 4 illustrates an isometric view of row unit 24 with the soil movement accessories (e.g. wheels and discs) removed. Each of the plurality of cantilevered arms 44 may be connected to the substantially cylindrical outer surface 48 of the hub 42. Each of the plurality of cantilevered arms 44 may include a proximal end portion 56 associated with the hub 42 and a distal end portion 58 configured to receive an attachment, such as a wheel 32 or a disc 34. The terms proximal and distal are used herein in relative to the hub 42, unless indicated otherwise.

As illustrated in FIGS. 4-7, the plurality of cantilevered arms 44 may include three arms 44a, 44b, 44c. A first and second cantilevered arm 44a, 44b may extend from opposing sides of the outer surface 58 of the hub 42. The proximal end portions of the first and second cantilevered arms 44a, 44b may extend from the hub 42 in generally opposite longitudinal directions. The distal end portions 58a, 58b of the first and second cantilevered arms 44a, 44 each may be configured to rotatably support a corresponding implement, e.g. closer wheel 32 (see FIG. 3).

The third cantilevered arm 44c may extend from the same side of the outer surface of the hub 42 as the second cantilevered arm 44b. The proximal end portion of the third cantilevered arm 44c may be laterally spaced apart from the proximal end portion of the second cantilevered arm 44b. The distal end portion 58c of the third cantilevered arm 44c may be configured to rotatably support a fertilizer furrow opening disc 34 (see FIG. 3).

In various embodiments, distal end portions 58a, 58b may be formed as mounting tabs extending from the cantilevered arms 44a, 44b. The distal end portions 58a, 58b may include mounting features 110a, 110b which are operable to selectively receive and support the implements such as press wheels, opening discs, closing discs, closing wheels, or the like. (See e.g. FIG. 3.) The mounting features 110a, 110b may include an elongated shaft that provides a bearing surface for the internal hub of the implements to ride on. The bearing surface may be a smooth surface or a threaded surface. In various embodiments, the mounting features 110a, 110b may be fixedly attached to the distal end portions 58a, 58b. The mounting features 110a, 110b may be integrally formed with the distal end portions 58a, 58b. For example, the mounting features 110a, 110b may be a welded stud or a cast stud extending from the distal end portion 58a, 58b. In such an embodiment, the mounting features 110a, 110b may be rotatably fixed and longitudinally fixed with respect to the length of the mounting features 110a, 110b.

In various embodiments, mounting features 110a, 110b may be removably attached to the distal end portions 58a, 58b. Such an embodiment may take a variety of forms. For example, a typical bolt may be used such that the mounting features 110a, 110b are rotatably movable and longitudinally movable. Such embodiments are illustrated in more detail in US. Patent Pub, No. US2013/0074747 and US. Patent Pub. No. US201310263767, wherein the mounting features 110a, 110b are referenced as pivots 375. As disclosed therein, the bolt/shaft may be freely rotatable in an aperture which extends through the distal end portions 58a, 58b.

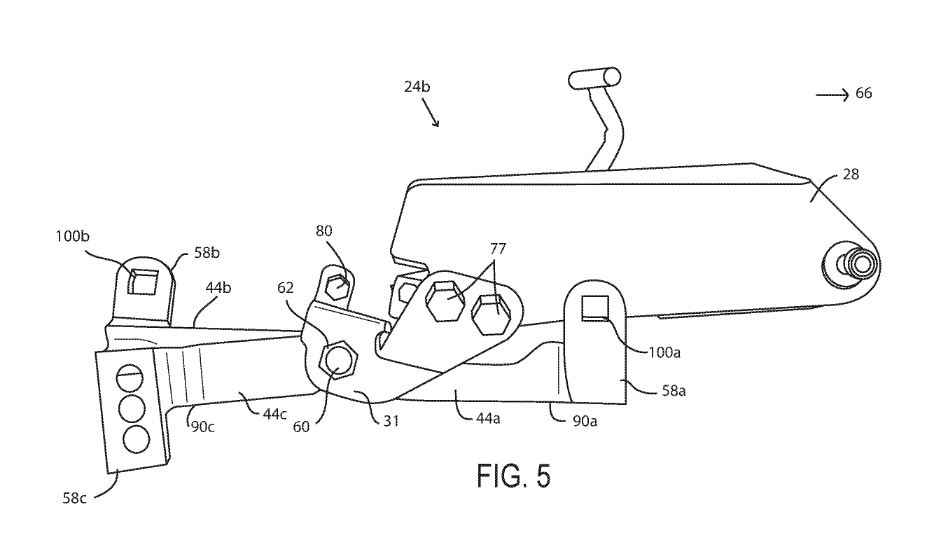

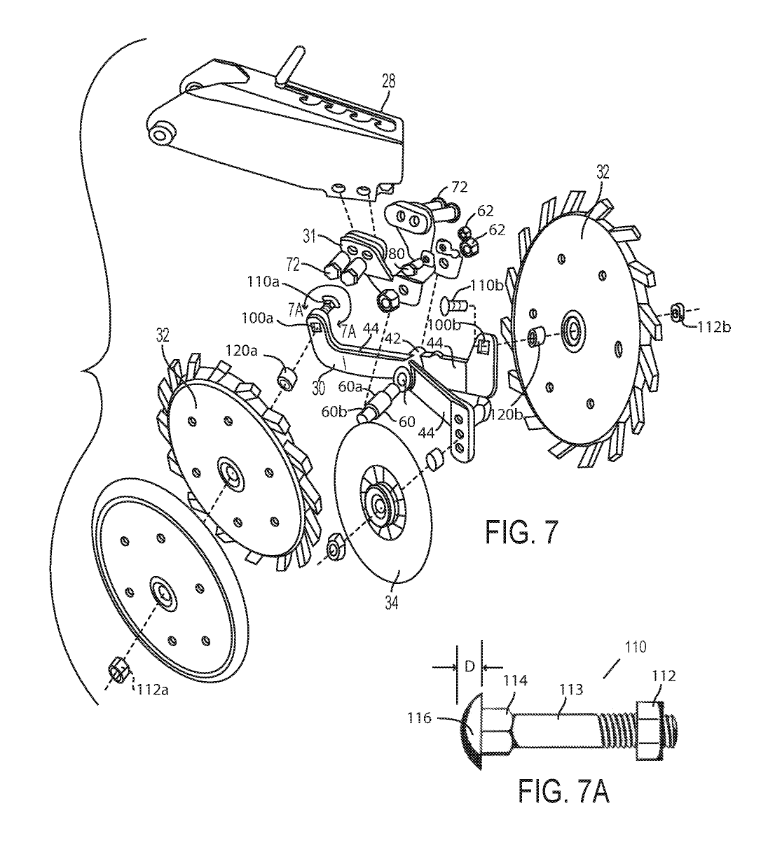

In another embodiment of removably attached mounting features 110a, 110b, the mounting features 110a, 110b may be limited in rotation. For example, the mounting features 110a, 110b may have a keyed engagement that engages the distal end portion 58a, 58b to prevent or limit rotation. As shown in FIGS. 5-9 and discussed in more detail below, the chassis 30 or, more particularly, the distal end portions 58a, 58b may include a keyed aperture 100a, b (e.g. square hole 100a, b) specifically shaped to engage a keyed portion 114 (an example of which is shown in the detailed view of FIG. 7A) on the mounting feature 110a, 110b. The keyed portion 114 may be a male protrusion with a larger cross-section than the shaft portion. The keyed portion 114 may be proximate to a head 116. In this structure, the shaft portion may pass through the keyed aperture without interference and the keyed portion 114 may engage the keyed aperture (e.g. 100a, 100b). In such an embodiment, the mounting features 110a, 110b may be rotatably fixed via the keyed portion 114 and the keyed aperture (e.g. 100a, 100b) but be longitudinally moveable in and out of the aperture. This configuration may allow the mounting features 110a, 110b to be selectively received into and removed from the apertures 100a, 100b while limiting the rotation of the mounting features 110a, 110b.

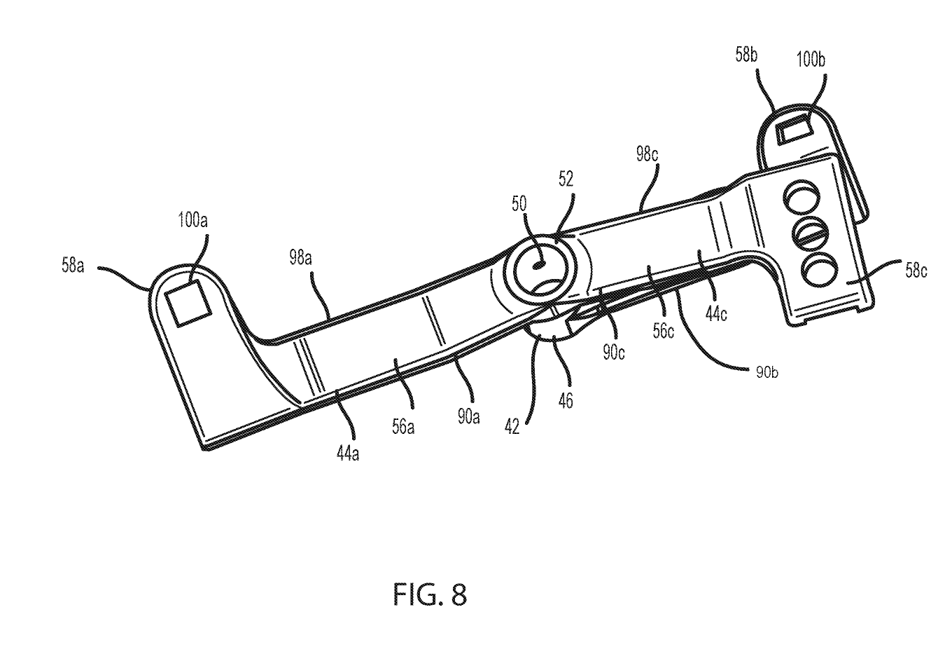

FIGS. 5-9 each illustrate various views of an example of the keyed aperture 100. The keyed aperture may be any shape that conforms to the keyed portion 114 of the mounting features 110a, 110b. The keyed aperture may also be shaped such that the shape limits or prevents the rotation of the keyed portion 114 when engaged within the aperture. The keyed aperture 100 may be structured such that it can be formed by a molding process. For example, the aperture extending through the end portion 58a, 58b may be formed by a molding tool having a side pull. In another example, the end portion 58a, 58b may be positioned at an angle relative to an upper tool half and a lower tool half such that aligned mating protrusions from the upper and lower tool halves can form the keyed aperture 100. FIG. 8 illustrates the chassis 30 by itself in what may be a single molded part.

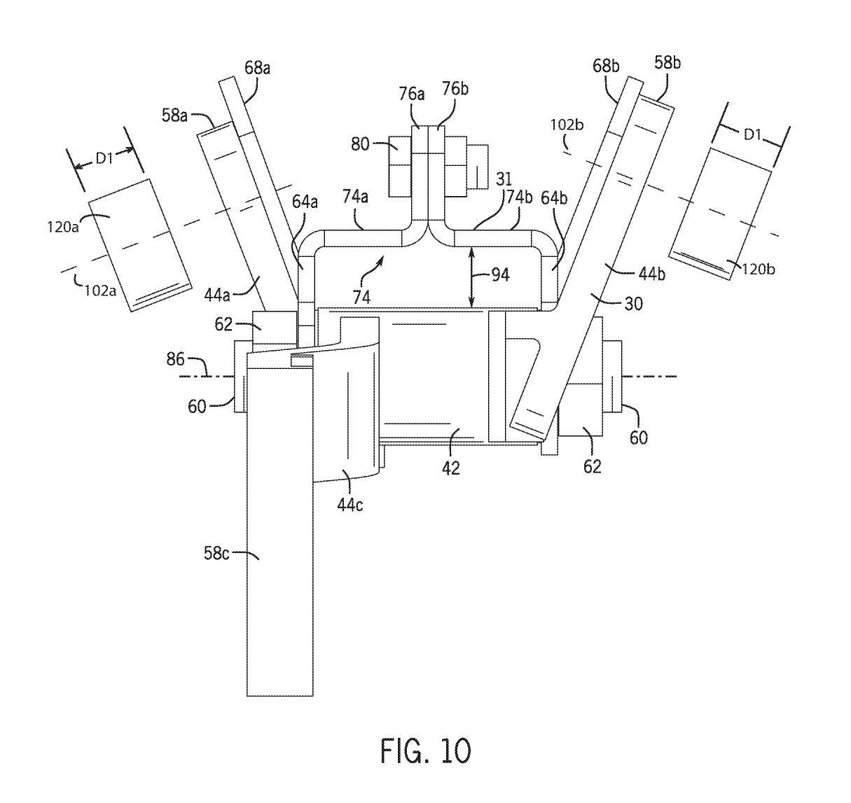

The keyed apertures 100a, b may be defined by shapes that are oblong, triangular, square, or with more than four sides. As illustrated, the shape may be a square that matches the keyed protrusion 114 shown in FIG. 7A. The keyed aperture 100a, b may be positioned on the end portion 58a, 58b such that the axis (shown in FIG. 10 as 102a, b) of the mounting feature 110a, 110b is positioned in correct location to position the two wheel/discs 32 relative to one another and also relative to chassis 30.

In various embodiments, the engagement between the mounting feature 110a, 110b and the distal end portion 58a, 58b may be configured to simplify assembly of the discs/wheels onto the chassis 30. For example, the rotation between the mounting feature 110a, 110b may be limited such that a disc/wheel (e.g. disc 32) and a retaining feature (e.g. retainer 112a, b) can be assembled onto the mounting feature 110a, 110b with a single tool. As one end of the mounting feature 110a, 110b may be captured in a keyed engagement, the mounting feature 110a, 110b may not rotate but the retainer 112a, b, which retains the disc/wheel 32, as shown in FIG. 7, may be able to rotate using a single wrench.

FIG. 7A illustrates a detailed view of FIG. 7 taken along line 7A-7A around an example of the mounting feature 110a, 110b. In one example, the mounting feature 110a, 110b, may be a bolt 110 having a rounded head 116, a keyed protrusion 114 from the rounded head, and a shaft 113. The shaft 113 may have a smooth portion functional as a bearing surface and/or a threaded portion operable to engage a retainer 112. The retainer 112 may be a nut, pin, cap or any similar retainer that is operable to hold the wheel/disc 32 onto the mounting feature 110. The mounting features 110a, b may be a carriage bolt.

The mounting features 110a, 110b may include implement adjustment devices 120a, 120b that are operable to space the implements (e.g. discs 32) away from chassis 30. The implement adjustment devices 120a, 120b may be separable from the mounting features 110a, 110b and/or the chassis 30. The implement adjustment devices 120a, 120b may be selectively removable from the mounting features 110a, 110b. As illustrated in FIG. 10, the implement adjustment devices 120a, 120b may have a width of D1. D1 may be modified by changing out different implement adjustment devices 120a, 120b to different widths. This adjustability may allow the implements 32 to be spaced at various different distances from the chassis 30. The operability of switching between different widths of implement adjustment devices 120a, 120b allows for the chassis and implements to be configured for different soils. For example, soybean seeds require less dirt during planting. As such, closing wheels may be set wider with the implement adjustment devices causing less dirt to be filled in over the soybean seeds. In another example, corn seeds require more dirt such that the closing wheels may be set closer together causing more dirt to be filled in over the corn seeds. Adjusting the position of the implements such as the closing wheels may also be beneficial in working on different soil conditions. For example, sandy soil should be less thick having wider closing wheel positions and clay might need thicker soil requiring a narrower closing wheel positions. In this way, the interchangeability of the implement adjustment device 120a, 120b allows a single planter assembly 12 to be useful for planting different seed types in different soil types.

In various examples, the mounting features 110a, 110b may be bushings (e.g. 120a, b shown in FIG. 10) operable to mate against the chassis 30 on a first side and contact the implement 32 on a second side. The bushing may be an oil-impregnated bushing operable as a low-friction bearing between the implement 32 and the chassis 30 mounted on the mounting features 110a, 110b.

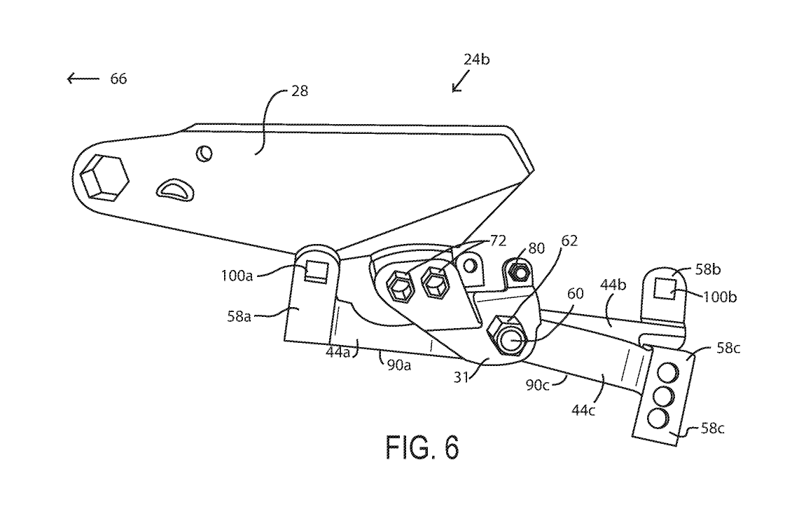

FIGS. 5 and 6 illustrate side views of different types of row units with the wheels, discs, and their respective shafts removed. These figures illustrate the interchangeability of the chassis 30 between the manufacturers of various planter units, including, for example, John Deere, Kinze, White, Great Plains, Monosem, and Yetter. As illustrated, FIG. 5 shows an example of a body 28 which is a Kinze planter body attached to chassis 30. As illustrated, FIG. 6 shows an example of a body 28 which is a Monosem planter body attached to chassis 30. With other chassis units some of the planters need modified in order to work with the chassis. For example, the Monosem planter unit had a side wall cut out to use with other types of chassis. However, in accordance with various embodiments discussed herein, the structure of chassis 30 may be utilized without modification of the planter unit. For example, as indicated above, the rounded head 116 of the mounting feature 110a, 110b, may be a low profile head. In one example, the head 116 may a low profile head (i.e. protrudes a shorter distance from the end portion 58a, 58b than a standard bolt of the same shaft diameter would). For example, the mounting feature 110a, 110b may extend less than the thickness of the end portion 58a, 58b from the side of the mounting tab opposite the side which receives the at least one of a furrow opener disc or furrow closer wheel. This low profile head reduces the interfering protrusion from the end portion 58a, 58b. With this reduced interfering protrusion, the end portion 58a, 58b may be able to dear the body 28 of the planter while articulating about its pivot point. In some embodiments, the head 116 may be Hush with the end portion 58a, 58b (e.g. in a countersunk aperture extending through the end portion 58a, 58b). In some embodiments, there may be no head 116 (e.g. the mounting features 110a, 110b may be studs welded or formed with the end portion 58a, 58). In some embodiments, the mounting features 110a, 110b may be carriage bolts having a lower head protrusion than similarly sized bolts. In each embodiment, the various manufacturers' planter body 28 may be cleared by the end portion 58a, 58b without interference by the mounting features 110a, 110d, protrusion in that direction.

The chassis 30 may include a hub 42 and plurality of cantilevered arms 44 connected to and extending away from the hub 42. The hub 42 may be a hollow body having a substantially cylindrical outer surface, a substantially cylindrical inner surface 50, and opposing lateral faces 52. The hub 42 may have a substantially uniform annular wall thickness. In one example, the hub 42 may be formed from a substantially cylindrical tube.

With continued reference to FIGS. 7, which illustrates an exploded top rear isometric view of the row unit illustrated in FIG. 4, the mounting bracket 31 may be pivotably coupled to the chassis 30 with a fastener, such as a cross pin 60 extending through the hub 42. As illustrated in FIG. 5, the cross pin 60 may include a central, substantially cylindrical bearing surface 60a and threaded ends 60b. The bearing surface 60a may have a larger outer diameter than the threaded ends 60b. The bearing surface 60a may rotatably bear against the inner surface 50 of the hub 42 during movement of the chassis 30 and the mounting bracket 31 relative to one another. Nuts 62 may be threadably mounted on the threaded ends 60b of the cross pin 60 to secure the mounting bracket 31 to the chassis 30 about the cross pin 60.

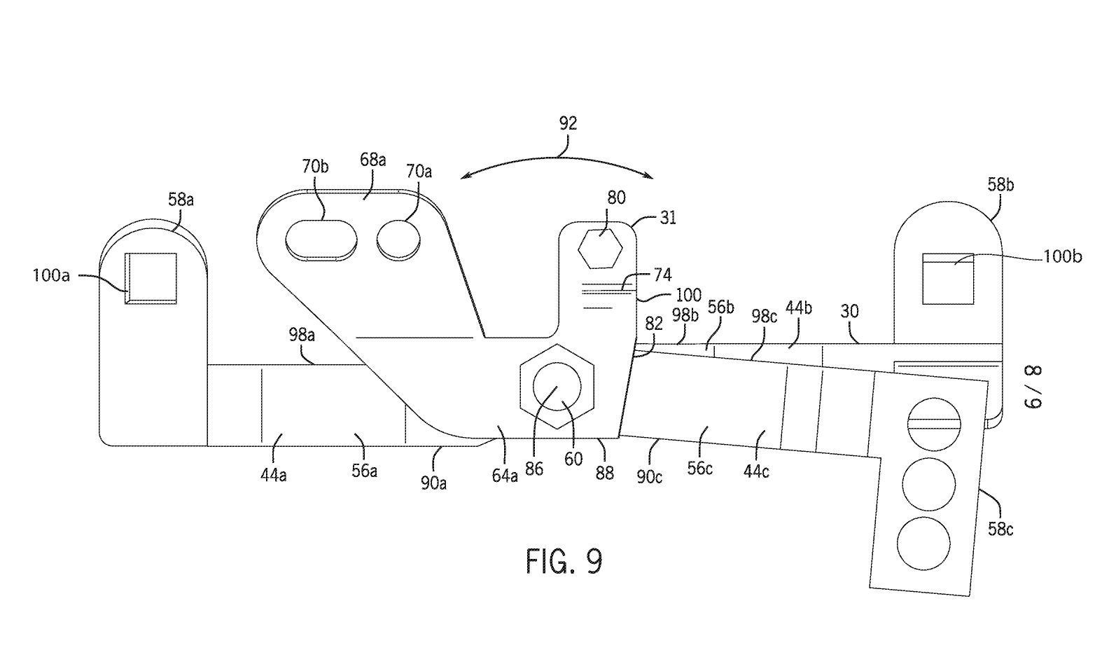

With reference to FIGS. 2, 3, 9, and 10, the mounting bracket 31 may be pivotably mounted to the chassis 30 and may be axially positioned along the chassis between the longitudinally-staggered wheels 32. As illustrated in FIG. 9, the pivot axis 86 of the mounting bracket 31 may be longitudinally positioned intermediate the distal end portions 58 a, 58b of the first and second cantilevered arms 44a, 44b, which may support the press wheels 32 as illustrated in FIGS. 2-3. The pivot axis 86may be positioned substantially equidistant between the rotation axes of the press wheels 32. The longitudinal positioning of the mounting bracket 31 may enable the wheels 32 to remain in contact with the ground in substantially all field conditions, thereby ensuring consistent closing of a furrow. For example, upon encountering debris or uneven ground in the planting area, the wheels 32 may pivot about the pivot axis 86 to remain in contact with the ground. The central positioning of the mounting bracket 31, which may serve as a load transfer path between the body 28 and the chassis 30, may apply a substantially equal amount of pressure on both press wheels 32, thereby keeping the tail section 24b of the row unit 24 in contact with the ground.

With reference to FIG. 9, the mounting bracket 31 may be configured to not obstruct a bottom profile of the chassis 30. As illustrated in FIG. 9, a lower or bottom edge 88 of the mounting bracket 31 may form a substantially smooth transition between the lower or bottom edges 90a, 90b, 90c of the proximal end portions 56a, 56b, 56c. In this configuration, the bottom profile of the row unit 24 may be substantially smooth and open beneath the chassis 30 and the mounting bracket 31 and between the distal end portions 58a, 58b, 58c of the chassis. This smooth, open bottom profile may allow debris to more easily pass between the chassis 30 and the ground without being caught or lodged, thereby reducing unintended ground disturbances.

The row unit 24 may have more ground clearance as compared to conventional row units due, at least in part, to the configuration of the mounting bracket 31. For example, as the mounting bracket 31 generally does not extend below the lower or bottom edges 90a, 90b, 90c of the chassis 30, the ground clearance of the row unit 24 a beneath the chassis 30 and between the wheels 32 may be greater than conventional row units. In some implementations, the mounting bracket 31 provides several inches of additional ground clearance as compared to conventional row units. In one specific implementation, the mounting bracket 31 provides about two inches of additional ground clearance by not impeding beyond a bottom profile of the chassis 30.

With reference to FIGS. 9-10, the mounting bracket 31 may be pivotable about the pivot axis 86 in opposing rotational directions 92. The pivotable range of the mounting bracket 31 may be larger than conventional mounting brackets, which may result in larger wheel travel of the press wheels 32 as compared to conventional row units. With reference to FIG. 10, the hub 42 of the chassis 30 may be positioned laterally between the sidewalls 64a, 64b and beneath the transverse top wall sections 74a, 74b of the mounting bracket 31. The top wall sections 74a, 74b may be generally coplanar with one another and may be positioned a distance or gap 94 above the hub 42. As the transverse top wall 74 of the mounting bracket 31 is positioned above the chassis 30, the distance 94 may be increased without impacting the ground clearance of the chassis 30 or the row unit 24. To increase the distance 94, the height of the sidewalls 64a, 64b may be increased in a direction extending upward from the chassis

An increased distance 94 between the transverse top wall 74 of the mounting bracket 31 and the chassis 30 may result in more travel of the wheels 32 as the chassis 30 may have a larger rotatable range relative to the mounting bracket 31. At one end of the rotatable range of the chassis 30, a front face 96 of the transverse top wall 74 of the mounting bracket 31 may abut or contact a top edge 98a of the proximal end portion 56 of the first cantilevered arm 44a (see FIG. 9). At the other end of the rotatable range of the chassis 30, a rear face 100 of the transverse top wall 74 of the mounting bracket 31 may abut or contact a top edge 98b of the proximal end portion 56b of the second cantilevered arm 44b, which may be positioned above a top edge 98c of the proximal end portion 56c of the third cantilevered arm 44c. As previously discussed, a stop may laterally protrude from a side surface of at least one of the cantilevered arms 44a, 44b, 44c. The at least one stop may be received within a notch or receptacle 82 formed in a sidewall 64a, 64b of the mounting bracket 31 to limit the rotatable range of the chassis 30 relative to the bracket 31. The stop may be formed as a pin with a substantially cylindrical cross-section, for example.

The parts of the row unit 24 may be constructed out of metal (such as aluminum, steel, metal, alloys, etc.), plastic, ceramic, or any other sufficiently strong and durable materials. The individual halves 31a, 31b of the mounting bracket 31 may be welded, bolted, screwed, or otherwise fastened together. Alternatively, the mounting bracket may be formed integrally as a single component by molding, machining, or otherwise fabricating the mounting bracket out of a single piece of material.

The example row unit provided herein may provide numerous advantages relative to conventional row units. For example, the row unit may include more ground clearance relative to conventional row units, which may be achieved without altering the ground clearance between the chassis and the ground. The row unit may include a substantially smooth bottom profile that may reduce debris from being caught or lodged beneath the row unit between the chassis and the ground. In one implementation, a mounting bracket may be configured to not substantially protrude beyond a lower or bottom surface of the chassis. In conventional row units, as a tractor pulls the row unit through the field, debris in the field may be caught, lodged, or wedged between the mounting bracket, the chassis, and/or the ground. By placing the mounting bracket along a top side of the chassis, the mounting bracket generally does not interfere with the ground clearance of the chassis.

As another advantage, the example row unit may include more wheel travel relative to conventional row unit. The additional wheel travel may be achieved by positioning a mounting bracket above the chassis and increasing a distance between a top wall of the mounting bracket and the chassis. The additional distance between a top wall of the mounting bracket and the chassis generally does not impact the ground clearance of the row unit as the top wall of the mounting bracket may be positioned above the chassis. Further, by positioning the mounting bracket along a top side of the chassis, the wheel travel of the row unit may be more consistent during operation as there may be less likelihood of debris being lodged between the mounting bracket and the chassis, which may impede the relative pivotal motion between the mounting bracket and the chassis. That is, the orientation of the mounting bracket may allow the chassis to rotate freely and evenly about a pivot axis, thereby ensuring proper seed and/or fertilizer placement.

Each of the various embodiments, examples, aspects, and elements of the disclosure herein may be combined with the various embodiments, examples, aspects, and elements of the disclosure of the U.S. Pat. No. 8,356.563; U.S. Patent Pub. No. 2013/0263767; U.S. Patent Pub. No. 2013/0074747; U.S. Patent Pub. No. 2014/0262371; and U.S. Patent Pub. No. 2013/0262381, which are incorporated herein by reference in their entirety. The various embodiments, examples, aspects, and elements of the disclosure of these incorporated references may also be combined with the disclosure herein as well.

All directional references (e.g., upper, lower, upward, downward, left, right, leftward, rightward, top, bottom, above, below, inner, outer, vertical, horizontal, clockwise, and counterclockwise) are only used for identification purposes to aid the reader's understanding of the examples of the invention, and do not create limitations, particularly as to the position, orientation, or use of the invention unless specifically set forth in the claims. Joinder references (e.g., attached, coupled, connected, joined, and the like) are to be construed broadly and may include intermediate members between a connection of elements and relative movement between elements. As such, joinder references do not necessarily infer that two elements are directly connected and/or in fixed relation to each other.

In some instances, components are described with reference to “ends” having a particular characteristic and/or being connected with another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like.

In methodologies directly or indirectly set forth herein, various steps and operations are described in one possible order of operation, but those skilled in the art will recognize that steps and operations may be rearranged, replaced, or eliminated or have other steps inserted without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with respect to particular apparatuses, configurations, components, systems and methods of operation, it will be appreciated by those of ordinary skill in the art upon reading this disclosure that certain changes or modifications to the embodiments and/or their operations, as described herein, may be made without departing from the spirit or scope of the invention. Accordingly, the proper scope of the invention is defined by the appended claims. The various embodiments, operations, components and configurations disclosed herein are generally exemplary rather than limiting in scope.

We claim:

1. A bracket for use with an agriculture planter comprising a trailing arm frame defining a pivot point thereon, the bracket comprising:
a first arm, a second arm, and a third arm, with each of the arms having a first end joined to a middle portion of the bracket, wherein two of the arms include second ends having mounting tabs with a rotatably fixed disc supports extending therefrom which are operable to selectively receive at least one of a furrow opener disc or furrow closer wheel; and
the two arms for receiving the fertilizer furrow opener disc enable two fertilizer furrows to be opened on opposing sides of a seed furrow.

2. The bracket of claim 1, wherein the rotatably fixed disc support includes portions that extend from both sides of the mounting tab.

3. The bracket of claim 1, wherein the rotatably fixed disc support extends less than the thickness of the mounting tab from the side of the mounting tab opposite the side which receives the at least one of a furrow opener disc or furrow closer wheel.

4. The bracket of claim 1, wherein the rotatably fixed disc support is received through and aperture in the mounting tab.

5. The bracket of claim 4, wherein the aperture in the mounting tab is square.

6. The bracket of claim 4, wherein the rotatably fixed disc support is a bolt which extends through and keys with the aperture.

7. The bracket of claim 1, wherein the rotatably fixed disc support is a carriage bolt.

8. The bracket of claim 1, wherein the rotatably fixed disc support receives a spacer on the side of the mounting tab that receives the at least one of a furrow opener disc or furrow closer wheel.

9. The bracket of claim 8, wherein the spacer is an interchangeable bushing that offsets the at least one of a furrow opener disc or furrow closer wheel away from the mounting tab.

10. The bracket of claim 6, wherein each of the first arm, the second arm, and the third arm, the middle portion, the mounting tab, and the apertures form an integral molded part.

11. A bracket for use with an agriculture planter comprising a trailing arm frame defining a pivot point thereon, the bracket comprising:
a first arm, a second arm, and a third arm, with each of the arms having a first end joined to a middle portion of the bracket, wherein two of the arms include second ends having mounts with selectively moveable disc spacers which are operable to selectively receive at least one of a furrow opener disc or furrow closer wheel, wherein the selectively moveable bushings position the at least one of a furrow opener disc or furrow closer wheel at varying distances from the bracket.

12. The bracket of claim 11, wherein each mount includes a rotatably fixed disc supports extending therefrom.

13. The bracket of claim 11, wherein the rotatably fixed disc support receives the selectively moveable disc spacer.

14. The bracket of claim 11, wherein the rotatably fixed disc support and the selectively moveable disc spacers are separable from the otherwise integral bracket.

15. The bracket of claim 11, wherein a first opener disc is received onto the rotatably fixed disc support and engages against the selectively moveable disc spacer thereby offsetting the first opener disc from a body of the agriculture planter.
